(19) United States
(12) Patent Application Publication
(10) Pub. No.: US 2025/0128636 A1
(43) Pub. Date: Apr. 24, 2025

(54) Method for identifying a device to be charged and controlling its charging process at a charging station

(71) Applicant: eClever technology GmbH, Dresden (DE)

(72) Inventor: Oliver Raguse, Bannewitz (DE)

(21) Appl. No.: 18/718,818

(22) PCT Filed: Dec. 12, 2022
(86) PCT No.: PCT/EP2022/085471

§ 371 Date: Jun. 12, 2024

(30) Foreign Application Priority Data
Dec. 12, 2021 (LU) 500993

(51) Int. Cl. B60L 53/68; B60L 53/30; B60L 53/65

(52) U.S. Cl. CPC B60L 53/68; B60L 53/305; B60L 53/65

(57) ABSTRACT

The present invention relates to the field of charging and controlling a charging process of a device to be charged, for example an electric vehicle, in particular charging of a device to be charged by a method for identifying and controlling the charging process of a device to be charged at a charging station in a public, semi-public or private space by impressing an electric signal by the charging station and assigning the impressed electric signal by a computing unit spatially remote from the device to be charged and the charging station. The method is characterized in that the remote computing unit comprises a computer-readable storage medium containing a computer program product containing instructions for identifying a device to be charged at a charging station and for controlling the charging process of a device to be charged at a charging station.

### TECHNICAL FIELD

The present invention relates to the field of charging and controlling a charging process of a device to be charged, preferably an electric vehicle, in particular the charging of an electric vehicle at a charging station with a three-phase, alternating current and/or direct current connection. The invention relates herein to a method for identifying a unit to be charged, preferably an electric vehicle at a charging station by impressing an electrical signal. Furthermore, the invention also relates to a method for controlling the charging process of a device to be charged identified at the charging station, in particular an electric vehicle, by means of a computing unit spatially remote from the device to be charged and the charging station.

### STATE OF THE ART

Electric vehicles and charging them are well known from the state of the art. Due to the still limited range of electric vehicles, charging times and energy requirements are relevant for planning orders, operational processes and cost estimates when using them, for example in a company's vehicle fleet. Favorable planning of charging times for the vehicle fleet also plays a role in connection with the company's sustainability profile and its commitment to environmental protection, as charging at times when renewable energies provide a large part of the energy supply is more environmentally friendly than, for example, charging at night when solar energy is not available.

In electric vehicles (unlike fuel cell vehicles), a battery management system (BMS) is typically installed, which regulates the supply of charging power and monitors the charging process by specifying the total permissible charging power and balancing the cell voltages between the individual cells of the battery. Status and error messages from the BMS can be read out using an on-board diagnostic system (OBD), which can be connected to the BMS via standardized connections. Nevertheless, it is possible that an electric vehicle is incompatible with a charging station, so that the charging process at this station cannot take place or can only take place with long delays due to a very low charging current. Furthermore, the BMS assigned to the electric vehicle only enables monitoring and control of the charging process of an electric vehicle. The BMS cannot be used to control and distribute power in the case of a fleet of electric vehicles that are to complete their charging process at different times, for example.

Another factor when charging electric vehicles that are part of a company's vehicle fleet is the clearance of the respective charging station, for example a company-internal charging station, for the electric vehicle connected to it. Various methods are known to prevent non-company vehicles from charging at the charging station.

DE 10 2020 205022A1, for example, discloses a means and method for authorizing a charging process at a charging station. First, a near-field interface is established between a user and a charging station. A user ID of the user signed with a signature key is then transmitted via the near-field interface, which is checked by the charging station to authenticate the user. The method also allows a comparison of condition records that are contained in a storage section of the authentication device and the charging station. The charging process is then authorized in a final step. The charging authorization can be verified and the condition records retrieved by identifying the user, for example using a key switch, an RFID chip in the form of a card or a token or a mobile end device. Authorization of the charging process via manual remote activation is also known from other areas. The disadvantages of such methods are the delay times caused by the identification process and the susceptibility to errors, in particular the deceptiveness of the options mentioned. In addition, special hardware is required in the charging station to read RFID chips in order to ensure identification.

DE 10 2020 114144A1 discloses a charging station for an electric vehicle, which has a near-field communication interface for near-field communication, designed to send and receive a data packet via the near field, and a wide-area network communication interface for wide-area network communication, designed to send and receive a data packet via the wide-area network, whereby the near-field communication interface is also designed to provide the wide-area network communication interface with a data packet for forwarding via the wide-area network. Authorization of a charging process for an electric vehicle by the charging station can be ensured even if there is no Internet connection via another authentication means, e.g. a mobile device.

Nevertheless, DE 10 2020 114144A1 also requires an authentication means, e.g. a smartphone, a tablet or an RFID card, to authorize the charging process and the user must consciously initiate an authentication process, which subsequently takes time.

DE 10 2018 128188A1 discloses a charging system comprising a plurality of charging stations, at least one memory module arranged to store charging station position-dependent charging curve characteristics and at least one charging curve determination module arranged to determine a charging curve for charging an electric vehicle connected to a first charging station based on position information of the first charging station and the stored charging station position-dependent charging curve characteristics. The charging system is further characterized in that the charging system comprises a curve adjustment module, which is arranged to enable the adjustment of a specific charging curve based on at least one real-time information. Real-time information herein refers to power grid parameters, meteorological parameters, status information of the connected vehicle and status information of the first charging station. By monitoring the charging curve of an electric vehicle in this way, it is possible to monitor and/or control the charging process of an electric vehicle with regard to the current conditions during charging, e.g. fluctuations in the electricity tariff, in the temperature and/or the state of charge of the electric vehicle's battery. However, it is not possible to identify the charging process based on the stored charging curve characteristics, especially as these fluctuate for an electric vehicle due to weather and ageing. It is also not possible for a user to control the charging curves and therefore adjust the charging process.

The identification procedure according to ISO 15118 is also known from the state of the art, which is a two-step identification method. In the first charging process, the electric vehicle is first identified once at a charging station by registering and authorizing the payment function. During each subsequent charging process, the electric vehicle is automatically identified by means of an exchange of certificates after it has been connected to the charging station with a charging cable. The disadvantage here is that attackers can read and imitate the certificates from the charging station using diagnostic tools, making it possible to charge an electric vehicle at such a charging station at the expense of another vehicle owner. The control of a charging process, in particular the decentralized control of the charging process, is also not implemented.

DE 10 2018 212 283 A1 discloses a method for identifying a charging station and an electric vehicle that are electrically connected to each other. A charging process of an electric vehicle at a charging station is identified based on the transmission of a signal by the charging station and detection of a signal by the electric vehicle. However, the method disclosed in the patent specification is based on the determination of a reaction time of one of the two charging partners and additionally on the detection of at least one time-related reaction characteristic of one of the two charging partners, so that the method is correspondingly slow, depending on the characteristics of the charging partners. A similar method is disclosed in DE 10 2015 210 726 A1, whereby the determination of a time-related reaction characteristic of one of the two charging partners is omitted, but the reaction time to an initiated stimulus must still be waited for in order to enable identification. As a result, this method is also slow and dependent on the properties of the charging partners in question.

DE 10 2011 007 912 A1, on the other hand, discloses a method for establishing an IP-based communication connection between the electric vehicle and the charging control unit, whereby a communication connection that can only be used by the electric vehicle and the charging station can be realized by means of an IP address assigned to the charging control unit. For identification purposes, this method also relies on the assignment of an IP address to the electric vehicle and the existence of a communication protocol that allows IP-based data exchange between the vehicle and the charging control unit. Data exchange via the pilot line of the vehicle charging cable is provided for this purpose. However, this method is based on the establishment of an IP-based communication connection, which takes place in several steps, and, like the identification method according to ISO 15118, is potentially readable by third parties.

DE 10 2019 202 201 A1 discloses a device and a method for controlling the transmission of electrical energy between a charging station and an electric vehicle, whereby a control signal is modulated onto the received supply voltage of the supply network via a connection unit. The method is characterized in that it comprises detecting the position of the vehicle and the control signal is executed as a function of the detected position of the vehicle. However, the determination of the vehicle's position is dependent on external factors and is prone to errors, particularly if, for example, the vehicle has poor GPS reception and/or a poor Internet and/or mobile phone connection.

DE 10 2013 212 221 A1 discloses a charging system comprising an electric vehicle and a charging station, which are electrically connected by a charging cable, whereby an exchange of physical parameters of the charging station device can be detected via a pilot line of the charging cable. The exchange of physical parameters between the charging station and the vehicle is used to create a parameter set characterizing the charging station, which can identify the charging station. Furthermore, control commands can be exchanged between the vehicle and the charging station via the pilot line of the charging cable. However, the charging system requires a sufficiently large data set to uniquely identify the charging station, so the process is correspondingly lengthy. In addition, changing a parameter can cause the process to fail.

A device for controlling a charging process and a method for charging an electric vehicle is described in U.S. Pat. No. 10,543,754 B2. The charging process is only started after the corresponding server has received an authorization message. Data on the charging quantity is also exchanged. The communication method used here uses two communication modules for short-range wireless transmission, one of which is arranged on the electric vehicle so that the electric vehicle can receive the information via it.

US 2018/0272886 A1 describes a charging system for vehicles. Information regarding the charging behavior is forwarded from the charging station to a server via a communication network. Furthermore, communication with the vehicle to be charged is also carried out by the server via a communication network to a communication module, which is arranged in the vehicle to be charged. The communication network used here is a peer-to-peer network. The hardware required for this is disadvantageously complex and costly to provide.

A charging arrangement for an electric vehicle is disclosed in US 2020/223319 A1. A charging plug is disclosed here for making contact with the vehicle, in which a voltage converter is integrated. This allows a high supply voltage of greater than 900 V to be adapted to a suitable charging voltage. A voltage supply cable is arranged between the charging station and the vehicle, which has electrical conductors for the charging process as well as at least one communication line via which data, in particular control commands, can be exchanged. Alternatively, wireless communication is proposed. However, such standardized communication variants are complex and time-consuming.

A vehicle and a method for controlling a vehicle and a charging system are described in U.S. Pat. No. 10,919,397 B2. The charging process of the vehicle is controlled and set via a control unit. The server can be dispensed with if alternating voltage is used for the charging process. If direct current is used for charging, a server is used. In the case of AC voltage supply, direct communication takes place via a separate line in the supply cable. For the variant using direct current charging, it is proposed to use CAN (Controller Area Network) communication between the charging station and the vehicle. However, the CHAdeMO standard is used here, in which a control unit of the vehicle transmits content to the charging station according to a master-slave system and thus initiates control of the charging process. The disadvantage of this is that no information can be transmitted from the charging station to the vehicle.

### Objective

It is therefore the objective of the present invention to enable the identification of one or more devices (1) to be charged, in particular one or more electric vehicles at one or more charging stations (2), as well as the control and/or termination of the charging process in a decentralized manner and without loss of time.

Optionally, it is the objective of the present invention to integrate different types of devices to be charged, in particular electric vehicles (e.g. regardless of the manufacturer of the electric vehicle and the possibly differing BMS and/or the age of the electric vehicle), partially or fully automatically into the system of a charging station network in a public, semi-public or private space.

The objective is also to provide a low-effort identification process that enables the charging process to be authorized without any further technical aids to be used by the user, i.e. without the need for identification and billing using smartphone apps, key switches or RFID cards, for example.

### Technical Solution

The objective is solved by a method which enables the identification of a device to be charged (1), in particular an electric vehicle, at a charging station (2) and the control of the charging process of an identified device, in particular an identified electric vehicle, at a charging station by a computing unit (4) which is spatially remote from the charging device and the charging station by means of a computer program product.

Furthermore, the technical objective is solved by providing at least one computer program product, wherein the at least one computer program product comprises instructions in the form of a program code and/or an algorithm which enable the identification of an electric vehicle at a charging station to be realized.

According to the invention, the objective is solved by a method according to claim 1, comprising a method for identifying a device to be charged (1) and/or controlling the charging process of a device to be charged (1), in particular an electric vehicle, at a charging station (2), in particular within a charging system (as defined herein) and/or within a charging network (comprising at least one charging station and at least two devices to be charged), in a public, semi-public or private space, characterized in that an arbitrary, easily resolvable electrical signal is impressed by the charging station, which is used to identify the device to be charged at the charging station by a computer program product. The method according to the invention comprises the following steps:
(a) preferably determining or testing a maximum charging power or a maximum charging current, in particular a maximum charging current, at a charging station (2) (S01),
(b) impressing an electrical signal with alternating amplitudes of current and/or voltage by the charging station (2) on the device to be charged (S02),
(c) recognition of the impressed electrical signal by a computing unit (3) (S03) assigned to the device to be charged (1),
(d) transmission (S04) of the recognized, impressed electrical signal to a computing unit (4) spatially remote from the device to be charged (1) and the charging station (2) by the computing unit (3) (S04) assigned to the device to be charged, in particular to the electric vehicle,
(e) assigning (S05) the transmitted, recognized, impressed electrical signal to the transmitting computing unit (3) assigned to the device to be charged (1) by the computing unit (4) from the previous step (S04) which is spatially remote from the device to be charged and the charging station,
(f) reporting the assigned device to be charged (1) to the charging station (2) by the computing unit (4) spatially remote from the device to be charged and the charging station (S06).

Conceptually, a device to be charged (1) is identified by impressing an electrical signal, preferably a pulse-width modulated signal, with alternating amplitudes directly onto a wire. The alternating amplitudes preferably run in steps, in particular according to a specific pattern. The signal for transmitting the value of the maximum current draw is preferably modulated, preferably pulse-width modulated, by a signal provided by electronics.

Conceptually, a device to be charged (1) is identified by impressing an electrical signal, preferably a pulse-width modulated signal, with alternating amplitudes directly onto a wire. The alternating amplitudes preferably run in steps, in particular according to a specific pattern. The signal for transmitting the value of the maximum current draw is preferably modulated, preferably pulse-width modulated, by a signal provided by electronics.

Preferably, the pattern of the impressed signal is stored on an information technology unit, e.g. the computing unit of the device to be charged and/or the remote computing unit and/or an adapter, e.g. in a database. This allows assigning (S05) the transmitted, recognized, impressed electrical signal of the device to be charged to that of the charging station by comparing the transmitted, recognized, impressed electrical signal with the pattern stored on the information technology unit. The “positive” assignment (i.e. the match) of the transmitted, recognized, impressed electrical signal of the device to be charged to the pattern stored on the information technology unit identifies the device to be charged as belonging to a charging system (as defined herein) and/or a charging network (comprising at least one charging station and at least two devices to be charged, e.g. a vehicle fleet) (identification). In this case, the device to be charged is reported (S06) to the charging station as a correspondingly assigned device to be charged, whereby the process of charging the device to be charged can or is authorized and consequently initiated (control). If the transmitted, recognized, imprinted electrical signal of the device to be charged does not match the pattern stored on the information technology unit (“negative” assignment), the device to be charged is identified as not belonging to the charging system (as defined herein) and/or the charging network (comprising at least one charging station and at least two devices to be charged, e.g. a vehicle fleet). In this case, reporting (S06) of the device to be charged as a correspondingly assigned device to be charged to the charging station is omitted, so that the process of charging the device to be charged is not authorized and consequently not initiated. Preferably, the charging process is aborted after a predetermined waiting time, for example 20 seconds (s), or at least identified as not belonging. A different technology can then be used, for example for billing, according to a staged principle. As a result, the method according to the invention offers additional security in vehicle authentication, as only a device to be charged, in particular an electric vehicle (1), can be identified, which has means, for example a computing unit (3) assigned to the device to be charged (1) and/or an adapter, which are set up to recognize (S03) the impressed electrical signal. This has the advantage of preventing charging devices, in particular electric vehicles, that are not part of the charging system and/or the charging network, e.g. the vehicle fleet, from initiating the charging process.

Consequently, in one embodiment, in the event that the transmitted, recognized, impressed electrical signal of the device to be charged is identified as belonging to the pattern stored on the information technology unit, and thus preferably the device to be charged is identified as belonging to a charging system (as defined herein) and/or a charging network (comprising at least one charging station and at least two devices to be charged, e.g. a vehicle fleet), the present method further comprises controlling (S07) the charging process after reporting (S06) the associated device to be charged (1) to the charging station (2).

The pattern of the imprinted signal can be altered or exchanged at time intervals. This can, for example, make it more difficult for unwanted users to pretend that their device to be charged is part of the charging system and/or the charging network. If the pattern of the imprinted signal is stored, for example, on the computing unit of the device to be charged and/or an adapter, the stored pattern can preferably be updated and/or exchanged by suitable means for data transmission as described herein. In one embodiment, the updating and/or exchanging of the stored pattern on an information technology unit takes place at a time when the pattern of the electrical signal to be impressed by the charging station on the device to be charged is also updated and/or changed. Preferably, the stored pattern is updated and/or exchanged on a daily basis.

The signal transmitted, preferably via the wire, can then be recognized by a computing unit assigned to the device to be charged, preferably the electric vehicle. The transmitted signal represents a kind of “code” via which a device to be identified and charged receives information from the charging station. This code can then be transmitted to a computing unit (4) that is spatially remote from the device to be charged and the charging station, whereby this spatially remote computing unit (4) performs the identification by assigning the electrical signal, which functions here as a code.

By recognizing and forwarding/transmitting the impressed electrical signal, it is possible to authenticate the device to be charged as belonging to a charging system and/or charging network (each as defined herein).

Preferably, when the signal, in particular the impressed electrical signal, is transmitted by the computing unit assigned to the device to be charged to the remote computing unit, an identification code associated with the device to be charged (also referred to herein as a self-disclosure identifier) is also additionally transmitted to the remote computing unit (4). In this way, individual identification of the device to be charged can be realized so that the charging system, in particular the remote computing unit, knows which specific device to be charged is connected to the charging station. In addition, the transmission of the identification code associated with the device to be charged allows the vehicle-specific (activation) control and/or regulation of the charging process, since vehicle-specific data (as defined herein) is also transmitted via the identification code and/or can be extracted from a corresponding database using the transmitted identification code.

Preferably, the recognition of the impressed electrical signal directly initiates the transmission of the impressed electrical signal and/or the identification code associated with the device to be charged. As a result, the assignment or identification is also realized automatically.

### General Advantages

The method is based on a secure identification method, as the signals from the charging station (2) and the identifier of the device to be charged (4) are checked and stored decentrally by a computing unit (4) spatially remote from the device to be charged and the charging station. The transmitted signals can be clearly assigned by the computing unit (4) spatially remote from the device to be charged (1) and the charging station (2) and cannot be evaluated and falsified by accessing the charging station. For example, the necessary hardware and software can be easily retrofitted to existing charging stations.

The use of a computing unit (4) spatially remote from the device to be charged (1) and the charging station (2) for identifying a device to be charged at a charging station additionally enables the monitoring of several devices to be charged at different charging stations that have been identified by the method according to the invention. Thus, the charging power can be controlled according to the current grid load and the electricity price, the operating times of the devices to be charged, in particular the electric vehicles to be charged and the compatibility of the device to be charged (1) with the charging station (2).

A further advantage is the automatic identification of the device to be charged (1) at the charging station (2) simply by coupling the device to be charged with the charging station, without the need for a further step (e.g. identification via key card, credit card, RFID, etc.).

The device to be charged is advantageously already identified by assigning (S05) the transmitted, recognized, impressed electrical signal to the transmitting computing unit (3) assigned to the device to be charged. The computing unit (4), which is spatially remote from the device to be charged and the charging station, assigns the signal and thus identifies the device to be charged; in particular, this allows the device to be charged to be assigned as belonging to the charging system or charging network.

The device to be charged is identified independently of time-related reaction characteristics of the device to be charged. It is therefore a fast identification method that does not depend on a reaction of the device to be charged to the signal impressed by the charging station or has to wait for such a reaction.

Furthermore, the method according to the invention has the advantage that the impressed signal provides an efficient and convenient means of assignment that does not require complex methods of data transmission using long signal keys.

It is also possible to identify the device to be charged (1) without the need for spatial localization of the device to be charged, e.g. via GPS, which is imprecise and/or time-consuming depending on the ambient conditions. In addition, it is even possible to locate the device to be charged remotely via the position of the charging station without using GPS data, for example. Due to the individuality of the imprinted signal, a specific imprinted signal can make it possible to assign the signal to a specific charging station. Based on the knowledge of the position of the charging station, a position determination of the device to be charged positioned at the charging station can be advantageously realized.

Possibly dispensing with GPS-based methods also has a favorable effect on data protection, including company data protection, for example.

Further advantageous embodiments and further developments can be derived from the sub-claims, the description and the embodiment examples.

### DETAILED DESCRIPTION OF THE INVENTION

First, in a step (S00) preceding steps S01 to S06, a device to be charged (1), preferably a vehicle, preferably an electric vehicle comprising a battery management system (BMS) (10), is physically and electrically coupled to a charging station (2) in a public, semi-public or private space, preferably via a charging cable (5). Alternatively, inductive coupling between the electric vehicle (1) and the charging station (2) is also possible.

In the context of the invention, the semi-public or private space refers to places that are not, or only partially, accessible to the general public. For example, the term can include a company-internal parking garage that is exclusively available to the company's employees, but also a parking facility that is available to both company employees and other persons. In such a case, it is necessary to ensure that only authorized personnel can use the charging infrastructure. Another example is an apartment building with a parking garage. Here, too, it must be ensured that only authorized residents can use the charging infrastructure.

The public space refers to the charging infrastructure accessible to the general public (e.g. pedestrians).

Furthermore, the device to be charged (1) is referred to herein as an electric vehicle. However, it is also possible to use the method disclosed herein for another device comprising a rechargeable battery and a BMS (10). Such a device can be, for example, a laptop, a tablet or a smartphone. The following designation of the device to be charged (1) as an electric vehicle is not to be understood restrictively.

For example, a charging station is set up for charging a device to be charged (1), in particular an energy storage unit therein, so that a device to be charged connected to the charging station or a connected energy storage unit can be charged. The charging process can be provided, for example, via the following four charging systems: (1) chargers with stabilized output voltage, (2) pulse chargers, (3) voltage-stabilizing and current-limiting chargers, (4) AC chargers.

In one embodiment, the charging station is detachably connected to the device to be charged. A detachable connection within the meaning of the invention comprises a form-fit, force-fit or material-fit connection or a combination of at least one of these, which is suitable for reversibly attaching the charging station to the device to be charged.

The invention also relates to a charging system which is suitable for identifying a device to be charged and for controlling the charging process of a device to be charged (1) and which comprises means adapted to carry out the steps of the method according to the invention.

In particular, the charging system comprises a device to be charged (1), preferably an electric vehicle with a battery management system, and a charging station (2) coupled to the device to be charged.

The charging system defined herein preferably has a means, in particular a sensor, which is set up to perform the step of determining and/or testing (S01) a maximum charging power or a maximum charging current at a charging station.

Preferably, in a method described herein, the impressing according to step (S02) is performed via pulse width modulation of the voltage signal. The charging system defined herein preferably has a means, in particular an actuator, which is set up to perform the step of impressing (S02) an electric signal with alternating amplitudes of current and/or voltage by the charging station. This is preferably an electronic system arranged within the charging station (2) which, for example, performs pulse width modulation of the voltage signal.

The charging system defined herein preferably has a means which is set up to perform the step of recognizing (3), preferably a detection unit for detecting the impressed electric signal, preferably a measuring unit for determining an electric power and/or an electric voltage and/or an electric current. Furthermore, according to an advantageous embodiment, the charging system has an on-board diagnostic system that recognizes incoming impressed electric signals and converts them into a digital data format. This enables automated further processing of the signal and transmission to a spatially remote computing unit (4).

Only the recognition of the impressed signal makes it possible to assign the recognized impressed signal to the device to be charged in a later step after a comparison with data stored in a database, which makes it possible to identify the device to be charged as well as the charging station to begin with.

Furthermore, the charging system has a computing unit (3) assigned to the device to be charged and a computing unit (4) remote from the device to be charged and the charging station.

The method according to the invention for identifying a device to be charged, in particular an electric vehicle (1), at a charging station (2) comprises preferably first checking the maximum charging power provided by the charging station, in particular the maximum charging current. In this way, it can be advantageously ensured that the required charging power is available (load management). Furthermore, the charging process can be estimated in terms of time and it is ensured that the electric vehicle (1) is compatible with the charging station (2). In this way, the charging station (2) can also ensure that the electric vehicle (1) and the battery assigned to it are not damaged by the charging process and that time schedules, for example in a company, which depend on the operational capability of an electric vehicle, can be adhered to.

The charging system defined herein preferably has a means, in particular a sensor, which is set up to perform the step of determining and/or testing (S01) a maximum charging power or a maximum charging current at a charging station.

The method according to the invention also comprises, in a further step, impressing an electric signal, in particular a current signal and/or a voltage signal, particularly preferably a current signal. For this purpose, the charging power, which is provided by the charging station (2) and made available to the device to be charged, in particular the electric vehicle (1), via the charging cable (5), is provided with a specific signal form (also referred to herein as a pattern).

The impressing of the electric signal can, for example, be controlled by an information technology unit (e.g. computer, electronic circuit).

The electric signal, in particular the charging power, especially preferably the current and/or voltage, can be specifically varied during the step of impressing and can take place in smaller or larger amplitudes and also possibly in shorter current times in order to hereby increase the precision for recognizing the impressed electric signal by a computing unit assigned to the device to be charged (1).

In a preferred embodiment, a resistance of the energy storage device and/or an intermediate circuit is therefore determined by means of a time-varying charging power, particularly preferably a time-varying current and/or a time-varying voltage. The profile of the time-varying current can be variable in pulses, whereby the pauses between the pulses can be of the same length or of different lengths. The pulses can be superimposed on an underlying profile. The design of the current profile is advantageously selected in such a way that parasitic influences can be isolated and, in particular, properties of the device to be charged come to the fore.

In the present invention, it has proven to be particularly advantageous that the impressing of the electric signal as a positively or negatively poled electric signal, in particular as a positively or negatively poled charging or discharging current, is applied in pulses (i.e. variable current increase and current decrease, followed by a holding time, followed by a current decrease or current increase) by the charging station to the device to be charged, e.g. the energy storage device. The holding time of such a charging pulse can, for example, be between a 1000th and a maximum of 600 seconds, preferably in the range between a 10th and a maximum of 60 seconds. The control of the impressing of the electric signal can be carried out by a computer or with a processor of a control device.

In one embodiment, a computing unit assigned to the device to be charged (1) (also referred to herein as an information technology unit) can adjust the strength of the electric signal, in particular the strength of the charging current and/or the charging voltage, particularly preferably the strength of the charging current depending on one or more than one measured value, in particular of the charging current, the charging voltage and/or the charging power, which is provided by the charging station to the device to be charged and/or arrives at the device to be charged, i.e. is determined-which is/are determined during the period of impressing.

It can be advantageous for the impressing of an electric signal to set several pulses of different holding times in different time sequences (“waiting time”), as well as with different signal rise or signal fall speeds, preferably current rise or current fall speeds. It may be advantageous to set the aforementioned times and/or current levels directly depending on the performance of the energy storage device and/or measured values in the charging station, in particular the voltage. It may be advantageous to repeat the described procedure several times in the same or adapted form.

The electric signal is impressed on at least one of the current-carrying lines or conductor contacts of the charging cable, e.g. on one of the outer phases, which are also referred to as phases P1 to P3, especially in a common three-phase electric vehicle charging cable according to the EN 62196 type 2 standard. This makes it possible to exchange control commands via the pilot line of a standard charging vehicle cable in parallel with the signal exchange for identifying the electric vehicle at the charging station.

A test of the charging power, in particular the maximum charging current, after step (S01) is also relevant in the method according to the invention in order to ensure that this maximum charging power, preferably the maximum charging current, is also taken into account in the following step (S02), i.e. when impressing the electric signal with alternating amplitudes of current and/or voltage. By limiting the charging power, preferably the charging current, it should be ensured that an overload of the supply line and the power grid is avoided. Impressing the electric signal must then be carried out in such a way that the resulting electric signal pattern complies with these safety limits. The impressed signal is sent to a device to be charged, where it is recognized by a computing unit assigned to the unit to be charged. Compliance with the safety limits can be achieved by simulating the resulting signal pattern to be transmitted or by keeping the electrical signals used, which are modulated, correspondingly small.

During the charging process, the charging station (2) provides a charging power according to the method according to the invention. The charging power is adjusted by the regulation and/or timed control of a charging power, preferably a charging voltage or a charging current, in particular the charging voltage at the output of the charging station (2), i.e. at the connection of the charging station and the connected charging cable (5). The voltage is AC voltage or DC voltage, preferably AC voltage.

In one embodiment, the electric signal generated by the charging station (2), particularly preferably a current signal, is designed in such a way that it is a periodic, i.e. temporally repeating current signal, whereby the amplitude of the periodic current signal alternates between at least two clearly distinguishable values. In particular, the current signal is a signal that is generated by a pulse-width modulated voltage signal. Preferably, the impressing of an electric signal with alternating amplitudes of current and/or voltage by the charging station is based on pulse width modulation. This analog signal transmission is advantageously uncomplicated to detect, especially if the resulting current values, in particular effective current values, between which alternation takes place, preferably differ by at least 1 ampere (A), preferably by at least 10% of the effective current value of the highest effective current value or the highest amplitude.

A typical pattern of an impressed electric signal is, for example, such that 6 A is transmitted for 2 seconds, then 12 A for 2 seconds and then 8 A for 2 seconds.

Preferably, the on-board diagnostic system recognizes the impressed signal so that information is transmitted to the AC/DC converter as to how fast charging is permitted. This information can also be compared with a target specification. The impressed electric signal acts as a code here, which is used for identification so that both billing and charging control are based on it. For example, different vehicles can be assigned different charging priorities. Prioritization is particularly relevant if there is a risk of overloading a network if all the devices to be charged are charged at the same time.

By pulse width modulation, the skilled person means a type of modulation. In this, an output signal with a fixed frequency, preferably a square wave signal, is modulated with the aid of an information signal different from it, e.g. a sawtooth signal or a sinusoidal signal or a square wave signal, in such a way that the time ratio between the time at which the output signal has a high amplitude (t1, switch-on time) and the time at which the output signal has a low amplitude (t2) can be varied. The sum of the time during which the signal is at low and high amplitude is referred to as the period duration (T). The ratio of the period duration T and the switch-on time t1 is referred to as the duty cycle. The duty cycle of a pulse-width modulated voltage signal on an electrical load can be used to set the amplitude of the current signal received by the electrical load.

The voltage signal is designed in such a way that the frequency of the pulse-width modulated voltage signal is preferably 1 kH, i.e. the switch-on time t1 of the voltage signal varies in a time range between 0.1 ms and 1 ms. For example, the information signal provided by the charging station (2) for generating the pulse-width modulated voltage signal is a periodic square-wave signal, sinusoidal signal or sawtooth signal, preferably a square-wave signal. Preferably, the pulse-width modulated voltage signal is sent periodically. A periodically repeated voltage signal can advantageously reduce the susceptibility to errors when identifying and detecting the impressed electric signal.

In a further embodiment, the electric signal generated by the charging station (2), particularly preferably a current signal, is designed in such a way that it is a one-time current signal, i.e. a one-time signal sequence. In particular, the current signal is a current signal that is generated by a pulse-width modulated voltage signal.

The voltage signal is designed in such a way that the frequency of the pulse-width modulated voltage signal is preferably 1 kH, i.e. the switch-on time t1 of the voltage signal varies in a time range between 0.1 ms and 1 ms. For example, the information signal specified by the charging station (2) for generating the pulse-width modulated voltage signal is a square-wave signal or a sinusoidal signal or a sawtooth signal, but preferably the square-wave signal. The time required for identification is advantageously reduced by sending the voltage signal once.

The pulse-width modulated voltage signal is set up in such a way that its amplitude varies between two clearly distinguishable values. Preferably, the amplitude of the voltage signal varies between minus twelve volts and twelve volts, particularly preferably between minus twelve volts and six volts. According to an advantageous embodiment, the amplitude varies by at least one volt, preferably by at least two volts, preferably by at least four volts.

In one embodiment, the impressed electric signal is a current signal. Preferably, the impressed electrical current signal alternates between six amperes and 32 amperes. Preferably, the value of the impressed current signal changes by at least two to eight amperes, particularly preferably two to four amperes, most preferably two to three amperes.

In a further embodiment, the impressed electric signal behaves in a stepped manner. The impressed electric signal alternates between a minimum amplitude, preferably at least six amperes, a maximum amplitude that is different from the minimum amplitude and at least one further amplitude that is clearly distinguishable from the maximum amplitude. The different amplitudes preferably differ by at least one, preferably at least two amperes.

The advantage of a type of signal generation and transmission according to the invention is that it is a clear and easy-to-read signal, namely an effective current or voltage. Effective refers to the average current or voltage transmitted over time. The evaluation of such a signal does not require complex signal processing or the use of a special data transmission protocol, such as the Internet protocol, which divides the information to be transmitted into data packets and ensures that these are transmitted to the correct address and that the information received is complete. Therefore, the method according to the invention is both robust and easy to implement. It can be carried out without the prior assignment of identification means, such as an IP address, to the electric vehicle and the charging station.

In a preferred embodiment, the impressed electric signal is an exclusively electric signal whose pattern is set exclusively by the modulation of the amplitude, the pulse width and/or the frequency of the current strength and/or the voltage and which, according to the invention, is transmitted from the charging station to the device to be charged via a current-carrying line or a phase contact of the charging cable, for example on one of the outer phases or a phase of the charging cable.

According to an advantageous embodiment, the impressed electric signal is a digital signal which, according to the invention, is transmitted from the charging station to the device to be charged via a current-carrying line or a phase contact of the charging cable, e.g. on one of the outer phases or a phase of the charging cable; preferably, the type of communication used is Power Line Communication (PLC). In this way, communication can be realized that meets the test and conformity requirements of the ISO 15118 standard. Advantageously, this enables uncomplicated communication with vehicles that are equipped in accordance with the ISO 15118 standard or that support the ISO 15118 standard. The imprinted digital signal preferably corresponds to the ISO 15118 GEN1 and/or ISO 15118 GEN2 standard. Preferably, a communication type and a charging cable are used that comply with this standard or one of these standards, so that a corresponding communication interface can be used.

For devices to be charged, in particular electric vehicles that do not meet this standard, especially older vehicles, a specially adapted charging cable and an adapted communication, preferably an analog signal, can be used. A pulse-width modulated signal, as described above, is suitable for this purpose.

The impressed signal is forwarded by the computing unit (3) in the vehicle to the computing unit (4) spatially remote from the device to be charged and the charging station and initiates the assignment process.

Such an alternating impressed electric signal can preferably be detected by the management system installed in the electric vehicle (1), in particular by the battery management system (BMS) (10) permanently installed in the electric vehicle, in such a way that the detected amplitudes of the impressed electric signal can be clearly distinguished. Advantageously, such a method can dispense with further electronics in the charging station (2), for example for reading an RFID tag or an interface for receiving a user-specific signal (e.g. for receiving credit card data).

Furthermore, the method according to the invention comprises recognizing the impressed electric signal detected by the BMS (10). In one embodiment, the impressed electric signal detected by the BMS (10) is recognized by a computing unit (3) that is external to the device, preferably external to the vehicle, and coupled to the BMS of the electric vehicle (1). The computing unit (3) is designed in such a way that it is preferably coupled to the BMS (10) via an on-board diagnostics (OBD) connection. By on-board diagnostics, the skilled person understands a vehicle diagnostics system that makes data and error messages collected from the vehicle regarding its function, including data from the BMS, readable and analyzable via standardized interfaces.

By coupling a non-vehicle computing unit (3) with the BMS (10) via a standardized interface, it is advantageously possible to evaluate the vehicle data for different vehicle types in the same way.

Preferably, the computing unit (3) assigned to the device to be charged is designed as a computing unit (3) that is external to the device or integrated into the battery management system (10) of the device to be charged (1). In one embodiment, the computing unit (3) assigned to the device to be charged (1) is a computing unit external to the device, which can preferably be coupled/connected, in particular coupled/connected, to a battery management system (10) of the device to be charged (1).

The non-vehicle computing unit (3) coupled to the BMS (10) of the electric vehicle (1) further comprises a storage medium containing a computer program product. In particular, the computer program product contains instructions that make it possible to read out the impressed electric signal detected by the BMS (10) by means of coupling via the OBD connection and convert it into a digital data format. This allows the impressed electric signal to be converted into a signal form that is favorable for transmitting the signal, i.e. that can be easily transmitted via a data communication interface.

For this purpose, the computer program product, when executed by a computer, causes the charging system to execute the step of recognizing (S03), in particular to execute the method steps of the method according to the invention. In doing so, the charging system recognizes the incoming impressed electric signal and converts it into a digital data format.

Furthermore, the non-vehicle computing unit (3) coupled to the BMS (10) of the electric vehicle (1) comprises a data communication interface. The data communication interface is preferably designed such that it enables data transmission by means of a wireless data transmission format. It may be intended that the data transmission from the non-vehicle computing unit (3) coupled to the BMS (10) of the electric vehicle (1) is realized via a wireless network to a computing unit (4) spatially remote from the charging electric vehicle and the charging station (2), or from the non-vehicle computing unit coupled to the BMS of the electric vehicle via a terminal device to a computing unit spatially remote from the charging electric vehicle and the charging station. For the purposes of the invention, a spatially remote computing unit refers to a computing unit (4) that is located at a location other than the charging station (2) and the electric vehicle (1) to be charged. For example, if the charging station (2) is a charging station installed at the location of a branch office of a company, the computing unit (4) spatially remote from the charging electric vehicle (1) and the charging station (2) may be located at a different location in the company headquarters. Preferably, the data transmission takes place via a standardized data transmission method, e.g. via Bluetooth, mobile radio (e.g. LTE or 5G), LoRaWAN or preferably WLAN.

In one embodiment, the external computing unit (3) assigned to the device to be charged (1) and coupled to the BMS (10) is designed in such a way that it has a communication interface that is set up to carry out data communication between this computing unit and the charging station (2).

In a further step, the detected impressed electric signal, which has been converted into a digital signal, is transmitted to a computing unit (4) spatially remote from the charging electric vehicle (1) and the charging station (2) in accordance with the method of the invention.

In one embodiment, the spatially remote computing unit (4) is a localized computing system, i.e. a physically tangible computing system arranged at a fixed location, comprising a storage medium for storing data, a processor unit for executing instructions, for example stored in a computer program product, and a data communication interface for transmitting and receiving data. This makes it possible to identify an electric vehicle (1) at a charging station (2) remotely and automatically.

In a further embodiment, the computing unit (2) spatially remote from the electric vehicle (1) and the charging station (2) is a delocalized computing system. For the purposes of the invention, a delocalized computing system refers to a distributed computing environment with the ability to store data and process data, wherein the computing environment comprises individual computing systems comprising at least one storage medium for storing data, at least one processor unit for executing instructions, for example stored in a computer program product, and at least one data communication interface for transmitting and receiving data. Preferably, such a distributed computing environment (also known as a cloud) is used to store a large amount of stored data in a fail-safe manner. If a single computing unit fails, it is advantageously ensured that all stored data is not lost.

The computing unit (4) spatially remote from the device to be charged (1), in particular from the electric vehicle (1), and the charging station (2) is set up such that, in a further step, it receives a detected impressed electric signal converted into a digital data format and assigns it by means of a computer program product both to a computing unit (3) coupled to the BMS (10) of an electric vehicle, in particular a non-vehicle computing unit, and to a charging station. Such a method advantageously enables the electric vehicle (1) to be assigned to the charging station (2) without the need for identification using hardware-intensive and/or cost-intensive technology, such as RFID chips or key switches. The assignment is preferably automated without requiring any input from the user. In this way, a device to be charged can be identified by the assignment after step (S05).

It is intended that the computing unit (4) spatially remote from the unit (1) to be charged, in particular from the electric vehicle (1) and the charging station (2), stores both all the impressed electric signals from different installed charging stations and specific identifiers assigned to the computing unit (3) assigned to the electric vehicle and connected to the BMS (10), which are integrated into the public, semi-public or private space.

Optionally, it is intended that the assignment of the impressed electric signal converted into a digital data format takes place via a predetermined algorithmic model. Preferably, the algorithmic model can be trained, for example using machine learning or artificial intelligence, as a function of all devices to be charged (1), in particular electric vehicles (1), and charging stations (2) that are integrated into the public, semi-public or private space.

In a final step, the method according to the invention comprises reporting the assigned device to be charged (1), in particular the assigned electric vehicle (1), to the charging station (2) by the computing unit (4) spatially remote from the electric vehicle and the charging station. The charging station (2) is set up in such a way that it comprises at least one storage medium for storing data, at least one processor unit for executing instructions, for example stored in a computer program product, and at least one data communication interface.

In one embodiment of the invention, reporting of the assigned electric vehicle (1) is carried out directly to the charging station (2) by the computing unit (4) spatially remote from the device to be charged, in particular from the electric vehicle, and the charging station. Such a method advantageously realizes a fast and uncomplicated identification of an electric vehicle (1) and enables the electric vehicles to be charged to be checked as to whether there is authorization for charging, whether sufficient capacity is available for the charging process and whether the electric vehicle is compatible with the charging station (2).

In a further embodiment, the assigned electric vehicle (1) is reported indirectly to the charging station (2), with the assigned electric vehicle and the assigned charging station first being reported to a non-vehicle computing unit (3) coupled to the BMS (10) of an electric vehicle. In a further step, the assigned electric vehicle (3) is then reported to the assigned charging station (2) by the non-vehicle computing unit (3) coupled to the BMS (10) of the electric vehicle (1). In addition to the above-mentioned advantages, this method offers additional security for vehicle authentication, as only an electric vehicle (1) that has a non-vehicle computing unit (3) coupled to the BMS (10) of the electric vehicle in accordance with the invention can be identified. This has the advantage of preventing electric vehicles that are not part of the own vehicle fleet from initiating the charging process. Preferably, the reporting of the assigned device to be charged (1) to the charging station (2) is carried out indirectly by the computing unit (4), which is spatially remote from the device to be charged (1) and the charging station (2), via the computing unit (3) that is external to the device and coupled to the battery management system (10).

In a further embodiment, the computing unit (3) assigned to the device to be charged (1) is integrated into a battery management system (10) of the device to be charged (1). Preferably, the computing unit (3) integrated into the BMS (10) of the device to be charged (1) is designed in such a way that it has a communication interface that enables data communication between this computing unit and the charging station (2).

According to an advantageous embodiment, the communication (“back communication”) from the device to be charged to the charging station, in particular also the reporting (S06), is carried out using a spatially remote computing unit, e.g. within a cloud, i.e. IP-based, or via the charging station.

In a specific embodiment, at least one further specific identifier (also referred to herein as a “self-disclosure identifier” or “identification code”) is transmitted to the charging station directly (by direct data transmission from the computing unit to the charging station) or indirectly (by indirect data transmission from the computing unit to the charging station, e.g. via an adapter, a mobile telecommunications device such as a smartphone, tablet, notebook) when reporting (S06) the device to be charged to the charging station.

In a preferred embodiment, transmitting the self-disclosure identifier to the remote computing unit, preferably together with step (c), and/or reporting (S06) the device to be charged to the charging station, including the self-disclosure identifier, comprises comparing this self-disclosure identifier with data stored in the remote computing unit (e.g. within a cloud) or with data (lookup tables) stored in the charging station relating to the specifications of the device to be charged, in particular at least one energy storage unit (e.g. batteries) arranged therein.

A lookup table includes, for example, data relating to the number and type of charging processes for this device to be charged, as well as reference data from the battery manufacturer. This data can, for example, be obtained from the manufacturers, who publish the corresponding key figures (e.g. nominal voltage, capacity). In an alternative embodiment, the key figures for more than one device to be charged, in particular for more than one electric vehicle and/or energy storage unit, are stored for the reporting step (S06). In a particularly preferred embodiment, the data stored in the remote computing unit is used to generate statistics on which the assessment of the performance of the assigned device to be charged, in particular at least one specific energy-storage unit arranged therein, is based. In a further advancement, the statistics initially comprise stored data on the energy-storing device, for example data of the manufacturer, whereby the statistics are extended by collected data in order to be able to better assess the performance of the specific or the assigned energy-storing device.

According to the invention, a spatially remote computing unit, e.g. within a cloud, comprises such a system which receives, processes, stores, transmits or sends determined measured values (e.g. voltage, current, temperature, humidity) by means of at least one information technology unit, or a combination of at least one of these. For the purposes of the invention, measured values comprise physical quantities that can be derived either directly or indirectly from the SI units. Measured values include, for example, temperature, time, distance (e.g. mileage in km), amperage, voltage, humidity, acceleration, speed. According to the invention, physical quantities can also be estimated, whereby certain physical quantities are used to estimate another physical quantity. The determination of measured values can be carried out directly or indirectly on at least one device to be charged and/or an energy storage unit and/or charging device and/or other element (e.g. adapter). The determination of measured values is carried out at intervals of time. A time period of the measurement includes, for example, the usage time of the device to be charged and/or the energy storage unit. A time period is also understood to be the time difference between an older and a more recent measurement. In one embodiment, a measurement is carried out at a point in time, whereby the measured values obtained are stored in order to make them retrievable, for example, during a later measurement. The measured values and/or data can be stored on the spatially remote computing unit and/or the adapter.

In one embodiment, an assigned computing unit and/or a spatially remote computing unit can adjust the strength of the charging current and/or the charging voltage depending on one or more than one measured value directly (by direct data transmission from the computing unit to the charging station) or indirectly (by indirect data transmission from the computing unit to the charging station, e.g. via an adapter, a mobile telecommunications device, such as a smartphone, tablet, notebook, hard disk, USB drive).

In a preferred embodiment, at least one information technology unit, e.g. the computing unit assigned to the device to be charged (1) and/or the spatially remote computing unit, compares the stored/stored data with the determined measured values. In a further embodiment, the determined measured values are transmitted to the spatially remote computing unit and compared there with the measured values of other devices to be charged.

In a particularly preferred embodiment, the information on each device to be charged, in particular the and/or each individual energy-storing unit (e.g. accumulator) therein, which is located within a defined charging network (comprising at least one charging station and at least two devices to be charged) and/or the charging system, which is charged via a charging station that is directly or indirectly connected to the remote computing unit, is stored for reporting (S06). This advantageously enables an algorithm and/or preferably an artificial intelligence (AI), which has access to the remote computing unit, to decide which device to be charged, in particular the and/or each individual energy-storing unit (e.g. accumulator) therein, is charged with which charging voltages and/or charging currents and/or charging times. The algorithm and/or the Al can therefore determine optimum charging curves. The advantage of this is that the algorithm and/or the Al can use modeling to determine the parameters that result in optimum performance of the device to be charged based on the measured values that develop differently over time for each device to be charged. In doing so, the algorithm and/or the Al must ensure that it only varies the parameters within a limited range so that no customer has to accept an intolerable negative impact on performance caused by the algorithm and/or the Al. The advantage of this is an improved performance of the energy-storing element.

In a further embodiment, not only the measured values of the specific or assigned device to be charged are stored in the spatially remote computing unit (e.g. a cloud) and/or processed by an algorithm and/or an AI, but also other measured values related to the device to be charged, such as the behavior of the user, remaining charging power, current, voltage, temperature and/or downtimes, are determined and processed. The measured values preferably come from more than one, particularly preferably more than a thousand and very particularly preferably more than a million devices to be charged, particularly comparable, particularly preferably identical in type, and/or devices to be charged, particularly energy storage units (e.g. accumulators) therein.

In a preferred embodiment, the method according to the invention is implemented with an adapter, which in one embodiment represents an information technology unit within the meaning of the present invention, in particular a computing unit assigned to the device to be charged, whereby one or more measuring devices can be integrated in this adapter. Preferably, the adapter is arranged in the device to be charged, for example via the on-board diagnostic system (OBD) and/or can be coupled/connected directly to the charging station, in particular coupled/connected within the charging system. Particularly preferably, the adapter is a computing unit assigned to the device to be charged, in particular a computing unit external to the device, which is preferably coupled/connected to a battery management system of the device to be charged. Advantageously, the adapter has control over the current output by the charging station. This is particularly advantageous if the charging station itself cannot establish contact with a remote computing unit (e.g. a cloud), but the adapter can. The adapter is advantageously set up for direct (by direct data transmission from the computing unit to the adapter) or indirect (by indirect data transmission from the computing unit to the adapter, e.g. via a mobile telecommunications device such as a smartphone, tablet, notebook) data transmission with the spatially remote computing unit. This means that the adapter, which is designed as the remote computing unit (3) assigned to the device to be charged (1) and coupled to the battery management system (10), is designed in such a way that it has a communication interface that is set up to carry out data communication between this computing unit and the charging station (2).

This adapter can then access the stored data in the remote computing unit and, depending on this data (as defined herein), regulates the charging time and/or the charging voltage and/or the charging current from the charging station to the device to be charged.

In one embodiment, the adapter establishes a direct or indirect connection to a computing unit, in particular to the spatially remote computing unit, in order to exchange data with it or to store data in it. In a preferred embodiment, the adapter establishes an indirect connection to one or more mobile telecommunications devices (e.g. smartphone, tablet, notebook) and/or a technical unit that is set up to process information technology signals in order to exchange data. An additional communication interface advantageously means that the charging station does not have to be coordinated with the battery management system (BMS). Instead, the additional communication interface ensures correct data exchange between the BMS and the charging station and/or at least one other IT unit.

The amount of energy delivered to the device to be charged, in particular to the energy storage unit (e.g. accumulators) therein, can be controlled, for example, via the adapter, e.g. via an information technology unit (e.g. computer, electronic circuit).

In one embodiment, the method according to the invention is set up in such a way that the charging process of an assigned device to be charged, in particular an assigned electric vehicle (1), can be controlled and/or terminated decentrally at the charging station (2). The control and/or termination of the charging process is preferably possible by a user or automatically with the aid of a computer program product.

To control and/or terminate the charging process of the electric vehicle (1), at least one computing unit is used in accordance with the invention, comprising a storage medium for storing data, a processor unit for executing instructions, for example stored in a computer program product, and a data communication interface. The computing unit is preferably a mobile computing unit, for example a smartphone, tablet or laptop. Advantageously, the control and/or termination of the charging process is carried out flexibly in terms of time and space.

In a further embodiment, the decentralized control and/or termination of the charging process of an assigned electric vehicle (1) is carried out via a computing unit (4) remote from the charging electric vehicle and the charging station (2). Preferably, the control and/or termination of the charging process of the assigned electric vehicle (1) is carried out automatically via a computer program product stored on the storage medium of the computing unit (4) remote from the charging electric vehicle and the charging station (2). Such a method advantageously enables an automated charging process for one or more electric vehicles (1) of a fleet, in particular a fleet of vehicles, for example, to be scheduled and coupled to a deployment or duty schedule, for example.

The method according to the invention further comprises a charging station (2) which enables charging by means of direct current, alternating current or three-phase current, which is set up in such a way that it contains at least one module which generates the above-described electric signal with alternating signal powers. Preferably, the module is an electronic unit (20) permanently installed in the charging station (2).

In one embodiment, the generation of the electric signal with alternating signal powers is carried out via the electronics (20) permanently installed in the charging station (2). Preferably, the impressed electric signal is a current signal, particularly preferably a current signal which is periodic, i.e. repeating in time, and has an amplitude which alternates between at least two clearly distinguishable values. Particularly preferably, the at least two clearly distinguishable values of the amplitude of the current signal are generated in that a voltage signal provided by the charging station (2) is pulse-width modulated by a circuit comprising the electronics (20). The circuit included in the electronics (20) is, for example, a switch and/or a toggle stage and/or an oscillator. Due to such a setup, the shape of the impressed electric signal is not dependent on further time-consuming calculations. This means that an electric vehicle (1) can be automatically identified at a charging station (2).

In a further embodiment, the generation of the electric signal with alternating signal powers is carried out via a computer program product, which is stored on a storage medium of the electronics (20) comprised by the charging station (2). Preferably, the charging station (2) is set up in such a way that it contains electronics (20) which generate the impressed electric signal with alternating signal powers according to step S02. Preferably, the impressed electric signal is a current signal, particularly preferably a periodic, i.e. temporally repeating, current signal, which has an amplitude that alternates between at least two clearly distinguishable values. Particularly preferably, the at least two clearly distinguishable values of the amplitude of the current signal are generated in that a voltage signal provided by the charging station is pulse-width modulated by a computing unit comprised by the electronics (20) by executing a computer program product. In this embodiment, the computing unit comprised by the electronics (20) is a microcontroller. This ensures that the current signal for identifying an electric vehicle (1) at a charging station (2) is advantageously variable and can be adapted to the current load on the grid.

In a further embodiment, the recognition of the impressed electric signal detected by the BMS (10) is carried out directly via the BMS of an electric vehicle (1) itself. The BMS (10) is designed in such a way that it comprises a storage medium containing a computer program product, a processor unit for executing instructions and a data communication interface for wireless transmission of data. In particular, the computer program product contains instructions that make it possible to convert the impressed electric signal detected by the BMS (10) into a digital data format. Thus, the impressed electric signal can be converted into a signal form that is favorable for transmitting the signal, i.e. that can be easily transmitted via a data communication interface.

In terms of the method according to the invention, the transmission of the detected impressed electric signal converted into a digital signal is carried out via the data communication interface comprised by the BMS (10) of the electric vehicle (1) for wireless transmission of data to a computing unit (4) remote from the charging electric vehicle and a charging station (2). By integrating the data transmission into the BMS (10), hardware can be advantageously saved and additional effort by retrofitting the electric vehicle (1) can be avoided.

A further aspect of the invention relates to the use of the method defined herein for controlling and/or terminating one or more charging processes of at least one device to be charged, in particular an electric vehicle (1) at an electric charging station (2) as described herein, in a public, semi-public or private space, as well as the evaluation and billing of the charging power called up.

The invention therefore also relates to a method for controlling the charging process of a device to be charged (1), in particular an electric vehicle, at a charging station (2), in particular within a charging system (as defined herein) and/or within a charging network (comprising at least one charging station and at least two devices to be charged), in a public, semi-public or private space, which comprises the following steps:
i. Impressing (S02) an electric signal with alternating amplitudes of current and/or voltage by the charging station (2) onto the device to be charged,
ii. recognition (S03) of the impressed electric signal by a computing unit (3) assigned to the device to be charged (1),
iii. transmitting (S04) a signal comprising information on at least one current charging parameter (in particular a current charging parameter initiated by the interaction or charging of the device to be charged with the charging station) to a computing unit (4) spatially remote from the device to be charged (1) and the charging station (2) by the computing unit (3) assigned to the device to be charged, in particular to the electric vehicle,
iv. comparing the transmitted signal, which comprises information on at least one current charging parameter, in particular the pattern of the transmitted signal, to the transmitting computing unit (3) assigned to the device to be charged (1) by the computing unit (4) spatially remote from the device to be charged and the charging station from the previous step (iii) with a first predetermined comparison value, in particular with the pattern of the impressed electric signal, particularly preferably with the pattern, in particular the stored pattern, of the impressed electric signal (in particular stored on an information technology unit within the meaning of the present invention, particularly preferably on a remote computing unit and/or on a mobile telecommunications device), from step (ii), and
v. if the transmitted signal from the transmitting computing unit (3) assigned to the device to be charged (1) deviates from the comparison value, in particular from the pattern of the impressed electric signal, particularly preferably from the stored pattern of the impressed electric signal: Adjusting, in particular adjusting in the form of a control, at least one charging parameter, the adjustment of the charging parameter preferably being carried out in such a way and/or for so long that the pattern of the transmitted signal matches the impressed signal, in particular until the pattern of the transmitted signal, in particular until the amplitude and/or pulse width and/or frequency of the transmitted signal, matches the pattern of the (originally) impressed electric signal. The control can thereby be carried out by increasing or decreasing a charging parameter, whereby the charging parameter is selected, for example, from the charging power, the charging current, the charging voltage and/or the charging time.

With the present method for controlling and/or regulating, in particular for regulating, the charging process of a device to be charged, it is possible to precisely track the status of the ongoing charging process and/or charging cycle by comparing electric signals. This allows possible deviations from the charging process, e.g. from the originally initiated charging protocol, to be detected precisely and reliably, and in conjunction with the initiation of an immediate “countermeasure”, preferably in the form of changing the charging speed and/or the charging voltages and/or charging currents and/or charging times.

Preferably, the pattern of the impressed signal is stored on an information technology unit, e.g. the computing unit of the device to be charged and/or the spatially remote computing unit and/or an adapter (as defined herein), e.g. in a database. This allows the transmitted signal, in particular the amplitude, the pulse width and/or the frequency of the transmitted signal, of the device to be charged to be compared with the pattern of the impressed signal stored on the information technology unit. If the pattern of the transmitted signal of the device to be charged matches the pattern of the impressed signal or does not exceed/fall short of a corresponding comparison pattern (“positive” comparison), the charging process and/or charging cycle runs correctly or at least within the tolerance. In this case, active control, in particular control in the form of regulation, of at least one charging parameter (e.g. the charging voltage and/or the charging current and/or the charging time) is not necessary. If the pattern of the transmitted signal of the device to be charged does not match the pattern of the (originally) impressed electric signal stored on the information technology unit or exceeds/falls short of a corresponding comparison pattern (“negative” comparison), the charging process and/or charging cycle does not proceed as desired/planned. In this case, active control, in particular control in the form of regulation, of at least one charging parameter (e.g. the charging voltage and/or the charging current and/or the charging time) is required. Preferably, the regulation of the corresponding charging parameter (which is preferably encoded by a change in at least one parameter selected from the amplitude and/or pulse width and/or frequency in the pattern of the signal) is carried out in such a way that the pattern of the transmitted signal, in particular until the amplitude and/or pulse width and/or frequency of the transmitted signal, corresponds to the pattern of the (originally) impressed electric signal. According to a preferred embodiment, the control of the corresponding charging parameter is carried out in such a way and/or so long until the pattern of the transmitted signal is brought back into conformity with the pattern, in particular the stored pattern, of the (originally) impressed electric signal. As a result, the method according to the invention offers a simple control option for monitoring and intervening in an ongoing charging process and/or charging cycle. In an extreme emergency, this allows the charging process to be stopped and/or restarted.

In one embodiment, the method according to the invention is set up in such a way that the charging process of an assigned device to be charged (1), in particular an assigned electric vehicle, can be controlled and/or terminated decentrally at the charging station (2). The control and/or termination of the charging process is preferably possible by a user or automatically with the aid of a computer program product. For example, the user can specify a deviation from the specified, e.g. determined, charging process. For this purpose, the user can change the charging time (e.g. indirectly by changing the desired departure time) or end the charging process, in particular via a mobile telecommunications device (e.g. smartphone, tablet, notebook) and/or a technical unit, e.g. intended to be located directly on the device to be charged (e.g. an eject button). As a result, a new signal to be impressed is preferably stored, preferably on the charging station and the remote computing unit.

In one embodiment, the charging current is adjusted and/or modulated in step (v). For example, the need to adjust and/or modulate the charging current is indicated by the fact that in the step of comparing the pattern of the transmitted signal with the pattern, in particular the stored pattern, of the impressed electric signal, the level of the amplitude(s) of the transmitted signal differs from the amplitude(s) of the impressed electric signal. For example, a higher amplitude in the transmitted signal compared to the impressed electric signal indicates a charging current that is too high and a lower amplitude in the transmitted signal compared to the impressed electric signal indicates a charging current that is too low. Accordingly, the charging current can be adjusted down or up and/or modulated in order to bring the pattern of the transmitted signal back into agreement with the pattern, in particular the stored pattern, of the (originally) impressed electric signal.

In one embodiment, the charging voltage is adjusted and/or modulated in step (v). For example, the need to adjust and/or modulate the charging voltage is indicated by the fact that in the step of comparing the pattern of the transmitted signal with the pattern, in particular the stored pattern, of the impressed electric signal, the period duration of the amplitude(s) of the transmitted signal deviates from the amplitude(s) of the impressed electric signal. For example, a narrower period duration and/or pulse width in the transmitted signal compared to the impressed electric signal indicates a charging voltage that is too high and a wider period duration and/or pulse width in the transmitted signal compared to the impressed electric signal indicates a charging voltage that is too low. Accordingly, the charging voltage can be adjusted down or up and/or modulated in order to bring the pattern of the transmitted signal back into line with the pattern, in particular the stored pattern, of the (originally) impressed electric signal.

In one embodiment, the end of the charging process and/or the charging cycle can nevertheless be indicated.

Preferably, the impressing of the electric signal according to step (i) is carried out by modulating the charging current and/or the charging voltage by superimposing the signal of the charging station, preferably provided by the electronics, during the charging process and/or charging cycle. Preferably, this allows the amplitude of the charging current and/or the charging voltage to be varied by the charging station.

In one embodiment of the invention, the measured values for determining whether a charging process and/or charging cycle is running correctly can be determined by the computing unit assigned to the device to be charged and/or by an adapter (as defined herein).

The use of the method according to the invention makes it possible to monitor and control, for example, a fleet of vehicles as an example of a charging network, in particular a fleet of electric vehicles of a company, adapted to the duty schedules and operating times of the electric vehicles (1), as well as to control the charging power delivered and to ensure the compatibility of the respective electric vehicles with the charging station (2) to which they are connected. In this way, it is advantageously possible to protect the vehicle fleet, in particular the electric vehicle fleet, to control the energy output and to optimize the charging processes of the fleet.

Using the method according to the invention for billing the power called up also allows an error-free assignment of a device to be charged, in particular an electric vehicle (1), to a charging process and also allows the costs to be controlled and the required power to be compared with the distance covered.

The present invention also relates to a charging system for identifying a device to be charged and/or for controlling the charging process of a device to be charged (1), in particular an electric vehicle, wherein the charging system has means which are adapted to carry out the steps of the method defined herein for identifying a device to be charged and, in the same way, the steps of the method defined herein for controlling the charging process of a device to be charged. The charging system preferably comprises a device to be charged (1) and a charging station (2). In particular, the charging system comprises a device to be charged (1) and a charging station (2) and the network (as defined herein). Preferably, the charging system is used to identify and/or control the charging process of a device to be charged (1), in particular an electric vehicle, at a charging station (2) in a public, semi-public or private space.

The charging system can also be designed as a charging network, whereby the charging network has at least one charging station and at least two devices to be charged, e.g. in the form of a so-called vehicle fleet.

The invention also comprises a computer program product (as defined herein) comprising instructions which, when the program is executed by a computer, cause the charging system described herein to perform the step of recognizing (S03), in particular the method steps, of the method described herein for identifying and controlling as well as the method for controlling the charging process of a device to be charged. Preferably, this computer program product is set up to recognize the respective incoming impressed electric signal and convert it into a digital data format.

The invention also comprises a network, in particular a charging network, which comprises computer systems, in particular a computer system for identifying and/or controlling as well as regulating the charging process of a device to be charged (1), in particular an electric vehicle, at a charging station (2), in particular a distributed computer system, e.g. a distributed fractionated computer system as defined herein.

Depending on specific implementation requirements, embodiments of the invention may be implemented in hardware or in software. The implementation may be performed using a digital storage medium, such as a floppy disk, a DVD, a Blu-Ray disc, a CD, a ROM, a PROM, an EPROM, an EEPROM or a FLASH memory, a hard drive or other magnetic or optical memory, on which electronically readable control signals are stored that can or do interact with a programmable hardware component such that the particular method is performed.

A computing unit may be formed by a processor, a computer processor (CPU=Central Processing Unit), a graphics processing unit (GPU=Graphics Processing Unit), a computer, a computer system, an application-specific integrated circuit (ASIC=Application-Specific Integrated Circuit), an integrated circuit (IC=Integrated Circuit), a single-chip system (SOC=System on Chip), a programmable logic element or a field-programmable gate array with a microprocessor (FPGA=Field Programmable Gate Array).

In general, embodiments of the present invention may be implemented as a program, firmware, computer program or computer program product comprising a program code or data, wherein the program code or data is effective to perform one of the methods when the program is running on a processor or programmable hardware component. The program code or data may, for example, also be stored on a machine-readable carrier or data carrier. The program code or data may be available as source code, machine code or byte code as well as other intermediate code.

### EXAMPLES OF IMPLEMENTATION

The present invention is explained in more detail with reference to the following figures and embodiments, without limiting the invention to these.

It shows

FIG. 1 A schematic view of a setup according to the method according to the invention for identifying a device to be charged (1), here an electric vehicle (1), at a charging station (2) and for controlling its charging process, wherein the electric vehicle (1) is coupled to the charging station (2) by the charging cable (5) and is designed in such a way that it has a BMS (10) and a non-vehicle computing unit (3) coupled to the BMS (10), and wherein the non-vehicle computing unit (3) is coupled to a computing unit (4) spatially remote from the electric vehicle (1) and the charging station (2) via a data communication interface, and wherein the charging station (2) comprises electronics (20) with a computing unit which is designed in such a way that it is coupled or can be coupled to the computing unit (4) spatially remote from the electric vehicle (1) and the charging station (2) via a data communication interface.

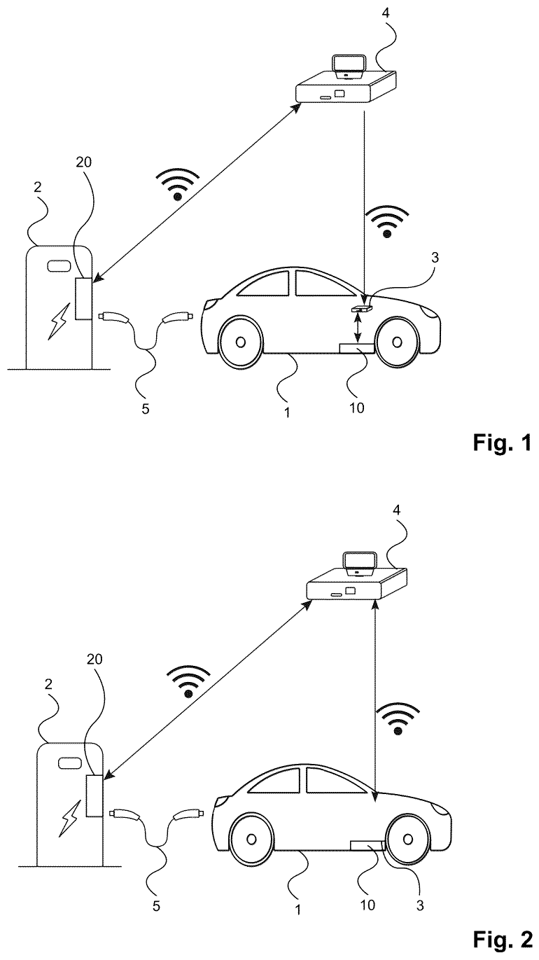

FIG. 2 A schematic view of a setup according to the method according to the invention for identifying a device to be charged (1), in this case an electric vehicle (1), at a charging station (2) and for controlling its charging process, wherein the electric vehicle (1) is coupled to the charging station (2) by a charging cable (5) and is designed such that it has a BMS (10) and a computing unit (3) integrated in the BMS (10) of the electric vehicle (1), and wherein the computing unit (3) integrated in the BMS (10) of the electric vehicle (1) is coupled to a computing unit (4) spatially remote from the electric vehicle (1) and the charging station (2) via a data communication interface, and wherein the charging station comprises electronics (20) with a computing unit which is designed in such a way that it is coupled or can be coupled to the computing unit (4) spatially remote from the electric vehicle (1) and the charging station (2) via a data communication interface.

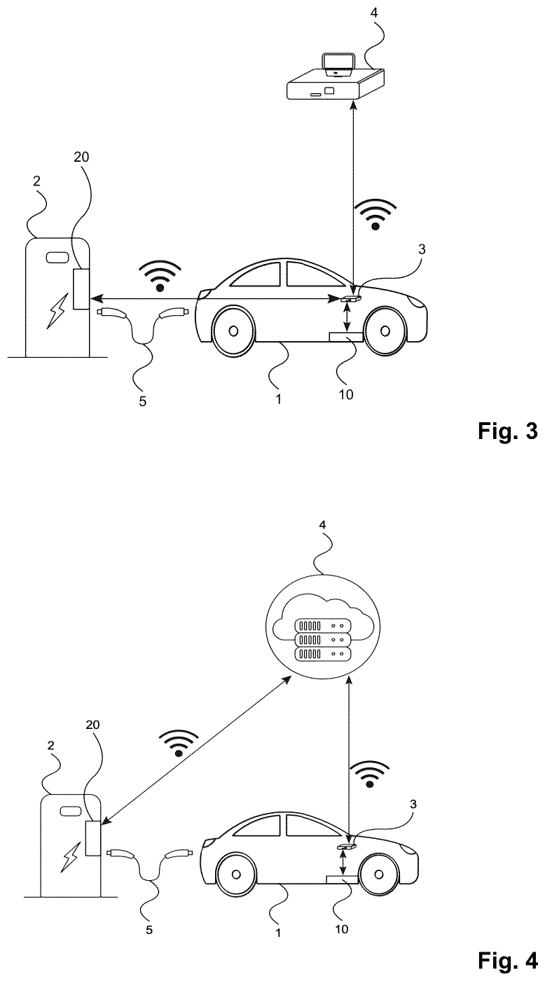

FIG. 3 A schematic view of a setup according to the method according to the invention for identifying a device to be charged (1), here an electric vehicle (1), at a charging station (2) and for controlling its charging process, wherein the electric vehicle (1) is coupled to the charging station (2) by a charging cable (5) and is configured in such a way that it has a BMS (10) and a non-vehicle computing unit (3) coupled to the BMS (10), and wherein the non-vehicle computing unit (3) is coupled to a computing unit (4) spatially remote from the electric vehicle (1) and the charging station (2) via a data communication interface, and wherein the charging station (2) comprises electronics (20) with a computing unit which is designed in such a way that it is coupled or can be coupled to the non-vehicle computing unit (3) coupled to the BMS (10) via a data communication interface.

FIG. 4 A schematic view of a setup according to the method according to the invention for identifying a device to be charged (1), here an electric vehicle (1), at a charging station (2) and for controlling its charging process, wherein the electric vehicle (1) is coupled to the charging station (2) by a charging cable (5) and is configured such that it has a BMS (10) and a non-vehicle computing unit (3) coupled to the BMS (10), and wherein the non-vehicle computing unit (3) is coupled to a computing unit (4) spatially remote from the electric vehicle (1) and the charging station (2) via a data communication interface which is set up in such a way that the remote computing unit (4) is a distributed computing environment, also cloud, and wherein the charging station (2) comprises electronics (20) with a computing unit which is designed in such a way that it is coupled or can be coupled to the computing unit (4) spatially remote from the electric vehicle (1) and the charging station (2) via a data communication interface.

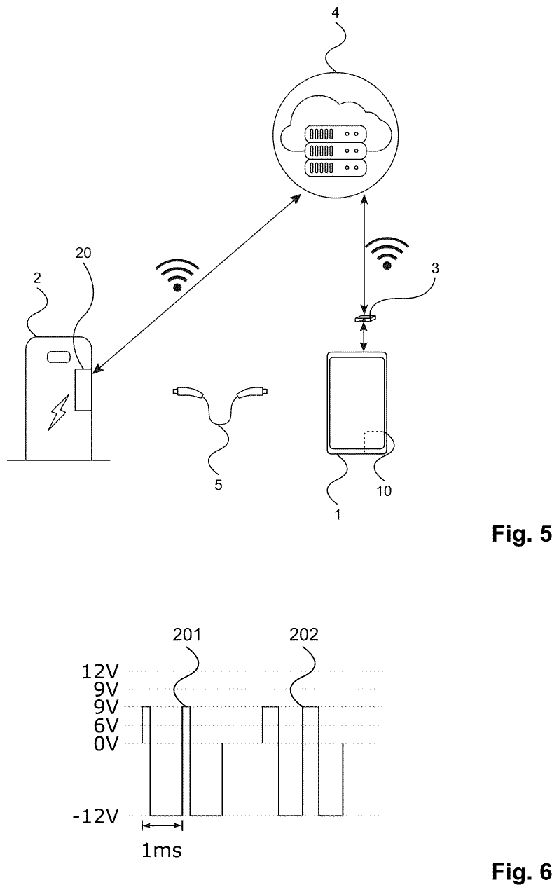

FIG. 5 A setup analogous to FIG. 4, whereby the device to be charged is designed as a smartphone.

FIG. 6 Voltage diagram for the pulse-width modulated voltage signal generated by the electronics (20) of the charging station (2)

In a first embodiment example, FIG. 1 visualizes the method according to the invention, comprising an electric vehicle (1) coupled to a charging station (2) by a charging cable (5). The coupling of the electric vehicle (1) is carried out by a charging cable (5) designed for this purpose, which is configured in such a way that it can transmit the power required for charging the electric vehicle (1). Assigned to the electric vehicle (1) is a non-vehicle computer unit (3) coupled to the BMS (10) of the electric vehicle (1), which is connected to the BMS (10) of the electric vehicle (1) via an OBD adapter. A further computing unit (4) is located spatially remote from the electric vehicle (1) and the charging station (2), which is designed in such a way that it is a localized, i.e. physically tangible, computing unit (4), in particular a PC.

In a first step (S01), the charging station (2) in this configuration specifies the maximum charging power provided by the charging station (2). In this embodiment, the maximum charging current is specified by the charging station (2).

In this embodiment, the charging station (2) impresses an electric signal in the next step (S02). This electric signal is a current signal. The current signal is set up in such a way that it is periodic, i.e. repeating in time, and designed in such a way that the amplitude of the periodic signal alternates between two clearly distinguishable values. In this embodiment, the current signal varies between the amplitudes of six amperes and ten amperes, whereby the current signal first has an amplitude of six amperes, then ten amperes and then six amperes again. In this embodiment, the current signal is a square-wave signal. The charging station (2) comprises electronics (20) for impressing the electrical current signal. The electronics (20) is set up in such a way that it pulse-width modulates a voltage signal provided by the charging station (2) by means of a circuit it comprises. In this embodiment, the circuit comprised by the electronics (20) is a circuit comprising at least one oscillator.

In a next step (S03), the impressed current signal is detected by a BMS (10) assigned to the electric vehicle (1). In this embodiment, the BMS (10) of the electric vehicle (1) is coupled to a non-vehicle computing unit (3) via an OBD connection. The non-vehicle computing unit (3) is designed in such a way that the impressed current signal detected by the BMS (10) can be read out by the computing unit (3) via the OBD connection. Furthermore, the computing unit (3) is designed such that it comprises a communication interface, a processor unit and a computer-readable storage medium, wherein the storage medium contains a computer program product which is designed such that it realizes the readout and transmission of the impressed electric signal detected by the BMS (10) of the electric vehicle (1) in an executable manner.

In this embodiment, the computing unit (4) spatially remote from the electric vehicle (1) and the charging station (2) is a PC. Further embodiments, in which the computing unit (4) is a laptop, a tablet or a cell phone, for example, are possible.

The first embodiment of the method according to the invention described herein comprises, in a further step (S05), assigning the received read-out impressed electric signal by the computing unit (4) spatially remote from the electric vehicle (1) and the charging station (2) to a transmitting computing unit (3) assigned to an electric vehicle (1) and a charging station (2). In this embodiment example, a database stored in the storage medium of the remote computing unit (4) is used.

In a next step (S06), the successful assigning of the received read-out impressed electric signal is reported to the charging station (2) by the computing unit (4) spatially remote from the electric vehicle (1) and the charging station (2). For this purpose, the electronics (20) comprised by the charging station (2) has a computing unit comprising a computer-readable storage medium, a processor unit and a communication interface, wherein the storage medium contains a computer program product which realizes the reporting of the successful assigning of the received read-out impressed electric signal by the computing unit (4) spatially remote from the electric vehicle (1) and the charging station (2) in an executable manner. Furthermore, the computer program product makes it possible to receive and implement commands for controlling and/or terminating the charging process of the connected electric vehicle (1) by the computing unit (4) spatially remote from the electric vehicle (1) and the charging station (2). Thus, the charging process of the connected electric vehicle (1) can be controlled and/or terminated by a user and/or an algorithm.

In this embodiment example, the communication interfaces of the computing unit (4) spatially remote from the electric vehicle (1) and the charging station (2), the computing unit (20) assigned to the charging station (2) and the non-vehicle computing unit (3) assigned to the electric vehicle (1) are designed in such a way that they enable data communication via WLAN.

In a further embodiment of the method according to the invention as visualized in FIG. 2, the computing unit (3) assigned to the electric vehicle (1) is a computing unit integrated into the BMS (10) of the electric vehicle (1). In this embodiment, the impressed current signal from the charging station (2) is detected by a BMS (10) assigned to the electric vehicle (1), analogous to the first embodiment example described. The detected impressed electric signal is transmitted by the computing unit (3) integrated in the BMS (10) to a remote computing unit (4), as described in the previous embodiment.

In a further embodiment example, FIG. 3 shows a setup analogous to the first embodiment example, comprising an electric vehicle (1), a charging station (2), a non-vehicle computing unit (3) assigned to the electric vehicle (1) and coupled to the BMS (10) of the electric vehicle (1) via an OBD connector, and a computing unit (4) spatially remote from the electric vehicle (1) and the charging station (2), whereby this is a localized, i.e. physically tangible, computing unit, in particular a PC. i.e. physically tangible computing unit, in particular a PC. Analogous to the first embodiment example, a maximum charging current is also specified here by the charging station (2), an electric signal, in particular a current signal, is impressed (S01), which is detected by the BMS (10) of the electric vehicle (1) and read out by the non-vehicle computing unit (3) coupled to the BMS (10) of the electric vehicle (1) and transmitted to the computing unit (4) remote from the electric vehicle (1) and the charging station (2). The computing unit (4) spatially remote from the electric vehicle (1) and the charging station (2) is carried out by assigning the received read-out impressed electric signal to the transmitting computing unit (3) and the charging station (2).

In a further step (S06), the computing unit (4) spatially remote from the electric vehicle (1) and the charging station (2) reports the assigned received read-out impressed electric signal to the non-vehicle computing unit (3) coupled to the BMS (10) of the electric vehicle (1) via an OBD connector. The non-vehicle computing unit (3) coupled to the BMS (10) via an OBD connector is set up in such a way that it has a communication interface, so that a signal can be transmitted to the electronics (20) comprised by the charging station (2) by the computing unit (3), which confirms the assignment carried out by the computing unit (4) spatially remote from the electric vehicle (1) and the charging station (2) and releases the charging process. The communication interface is set up in such a way that it enables data communication between the non-vehicle computing unit (3) coupled to the BMS (10) of the electric vehicle (1) via an OBD connector and an electronic unit (20) assigned to the charging station (2), comprising a computing unit, via WLAN or another radio connection. The charging process can be controlled and/or terminated by the computing unit (4) remote from the electric vehicle (1) and the charging station (2) via the non-vehicle computing unit (3) coupled to the BMS (10) of the electric vehicle (1) via an OBD connector.

In a further embodiment, FIG. 4 shows a computing unit (4) remote from the electric vehicle (1) and the charging station (2), which is designed in such a way that it is a distributed computing environment. In the context of the invention, a distributed computing environment refers to a computing system comprising a plurality of separate computing units that can realize data exchange via communication interfaces. In this embodiment example, the distributed computing unit is a cloud.

In this embodiment example, the computing unit (3) coupled to the BMS (10) of the electric vehicle (1) transmits the read-out impressed electric signal to the distributed computing unit (4) spatially remote from the electric vehicle (1) and the charging station (2), which reports the signal to the charging station (2) in a further step (S06) and thus makes it possible to control and/or terminate the charging process of the electric vehicle (1).

Alternatively, another embodiment is also conceivable in which the electric vehicle (1) is coupled to the charging station (2) via induction for charging. The charging station (2) comprises a coil which is arranged in an area around the charging station (2), characterized in that the charging station (2) induces a magnetic field in the coil by an applied electrical power, in particular by an applied voltage or a current flowing through the coil. The current signal is generated by the charging station (2) via a change in the magnetic field of the coil. The BMS (10) assigned to the electric vehicle (1) detects the impressed electric signal, which is read out and further processed in the same way as in the first embodiment.

In a further embodiment example, FIG. 5 shows a setup as in FIG. 4, whereby the device to be charged is a smartphone (1). In this embodiment example, the computing unit (3) coupled to the BMS (10) of the smartphone (1) transmits the read-out impressed electric signal to a distributed computing unit (4) spatially remote from the smartphone (1) and the charging station (2), which reports the signal to the charging station (2) in a further step (S06) and thus makes it possible to control and/or terminate the charging process of the smartphone (1).

FIG. 6 illustrates the generation of the impressed electrical current signal via a pulse-width modulated voltage signal specified by the charging station (2). The charging station (2) is set up in such a way that it comprises electronics (20), the electronics (20) comprising a circuit designed to generate a pulse-width modulated voltage signal. In this embodiment example, the voltage signal is a square-wave signal with a maximum amplitude of six volts and a minimum amplitude of minus twelve volts. The switch-on times t1 of the voltage signal are 0.16 ms in a first duty cycle (201) and 0.24 ms in a second duty cycle (202). In the first duty cycle (201), charging power is provided for an electric vehicle (1) 16% of the time, which corresponds to a charging current of ten amperes. In the second duty cycle (202), charging power is provided for the electric vehicle 26% of the time, which corresponds to a charging current of 16 amperes. The current signal is thus designed in such a way that its amplitude is initially ten amperes and then 16 amperes. In the next step, the current signal is detected by a BMS (10) assigned to the electric vehicle (1) and evaluated according to the steps explained in the previous embodiments.

In addition, it should be pointed out that the person skilled in the art will undoubtedly recognize that the individual features described in the above specific embodiments can be combined with one another in an appropriate manner, provided there is no contradiction, whereby a separate description of various possible combinations is dispensed with in order to avoid unnecessary repetition.

### LIST OF REFERENCE SYMBOLS

1 Device to be charged
2 Charging station
3 Computing unit assigned to the device to be charged
4 Computing unit spatially remote from the device to be charged and the charging station
5 Charging cable
10 Battery Management System (BMS)
20 Electronics assigned to the charging station
201 First duty cycle
202 Second duty cycle

1-30. (canceled)

31. A method for identifying and/or controlling the charging process of a device to be charged (1), in particular an electric vehicle at a charging station (2) in a public, semi-public or private space, comprising the following steps:
a) impressing (S02) an electrical signal with alternating amplitudes of current and/or voltage through the charging station (2)
b) recognition (S03) of the impressed electrical signal by a computing unit (3) assigned to the device to be charged (1),
c) transmission (S04) of the recognized, impressed electrical signal to a computing unit (4) spatially remote from the device to be charged (1) and the charging station (2) by the computing unit (3) assigned to the device to be charged,
d) assigning (S05) by comparing the transmitted, recognized, impressed electrical signal to the transmitting computing unit (3) assigned to the device to be charged (1) by the computing unit (4) spatially remote from the device to be charged (1) and the charging station (2) from step (S04),
e) reporting (S06) of the assigned device to be charged (1) to the charging station (2) by the computing unit (4) spatially remote from the device to be charged (1) and the charging station (2)
f) controlling (S07) the charging process after the reporting (S06) of the assigned device to be charged (1) to the charging station (2), in particular by initiating the charging process,
characterized in that
the impressing (S02) of the electric signal stipulates that the charging power provided by the charging station (2) and made available to the electric vehicle (1) via the charging cable (5) is provided with a specific pattern
the pattern can be set exclusively by modulating the amplitude, the pulse width and/or the frequency of the current and/or the voltage, and that
the impressing of the electric signal is carried out on at least one outer phase.

32. The method according to claim 31, wherein the method comprises determining (S01) a maximum charging power or a maximum charging current at a charging station (2) prior to the step of impressing (S02) the electrical signal.

33. The method according to claim 31, wherein the step of impressing (S02) is performed by a pulse width modulation of the voltage signal.

34. The method according to claim 31, wherein the control of the charging process is carried out by regulating and/or adjusting a charging power at a connection of the charging station (2) and a charging cable (5) over time.

35. The method according to claim 31, wherein the computing unit (3) assigned to the device to be charged is designed as a computing unit (3) external to the device or integrated into the battery management system (10) of the device to be charged (1).

36. The method according to claim 31, wherein an identification of a device to be charged (1) is carried out by the assigning according to step (S05).

37. The method according to claim 31, wherein a charging process of the device to be charged (1) assigned to the charging station (2) is controlled and/or terminated decentrally.

38. The method according to claim 37, wherein the decentralized control and/or termination of the charging process takes place via the computing unit (4) spatially remote from the device to be charged (1) and the charging station (2).

39. The method according to claim 31, wherein the charging station (2) is set up in such a way that it contains electronics (20) which generate the impressed electrical signal with alternating signal powers according to step S02.

40. The method according to claim 31, wherein the reporting (S06) of the assigned device to be charged (1) is carried out directly to the charging station (2) by the computing unit (4) spatially remote from the device to be charged (1) and the charging station (2).

41. The method according to claim 31, wherein the computing unit (3) assigned to the device to be charged (1) is a computing unit external to the device to be charged (1), which is coupled/connected to a battery management system (10) of the device to be charged (1).

42. The method according to claim 41, wherein the computing unit (3) assigned to the device to be charged (1) and coupled to the battery management system (10) is designed in such a way that it has a communication interface which is set up to carry out data communication between this computing unit and the charging station (2).

43. The method according to claim 42, wherein the reporting of the assigned device to be charged (1) by the computing unit (4) spatially remote from the device to be charged (1) and the charging station (2) to the charging station (2) is carried out indirectly via the computing unit (3) external to the device to be charged and coupled to the battery management system (10).

44. The method according to claim 31, wherein the computing unit (3) assigned to the device to be charged (1) is integrated into a battery management system (10) of the device to be charged (1).

45. The method according to claim 44, wherein the computing unit (3) integrated into the battery management system (10) of the device to be charged (1) is designed in such a way that it has a communication interface which enables data communication between this computing unit and the charging station (2).

46. The method according to claim 45, wherein the reporting of the assigned device to be charged (1) by the computing unit (4) spatially remote from the device to be charged (1) and the charging station (2) to the charging station (2) is carried out indirectly via the computing unit (3) integrated in the battery management system (10) of the device to be charged (1).

47. A charging system for identifying and/or controlling a device to be charged or for controlling the charging process of a device to be charged (1), comprising means adapted to perform the steps of the method according to claim 31.

48. A computer system comprising a computer-readable medium on which a computer program product comprising instructions which, when the program is executed by a computer, cause the charging system according to claim 47 to perform the step of recognizing (S03), in particular the method steps of the method for identifying and/or controlling the charging process of a device to be charged (1) is stored and a data communication unit, wherein the computer system is arranged such that the recognized impressed electrical signal converted into a digital data format is transmitted to a spatially remote computing unit (4).

49. A computer system comprising a computer-readable medium on which a computer program product comprising instructions which, when the program is executed by a computer, cause the charging system according to claim 47 to carry out the method for identifying and/or controlling the charging process of a device to be charged (1), wherein the charging process is controlled and/or terminated after the assigned device to be charged (1) has been identified is stored and a data communication unit, wherein the computer system is arranged such that the impressed electrical signal converted into a digital data format and assigned to a transmitter and a charging station (2) is transmittable to the charging station (2).

50. A computer system comprising a computer-readable medium on which a computer program product comprising instructions which, when the program is executed by a computer, cause the charging system according to claim 47 to carry out the method for identifying and/or controlling the charging process of a device to be charged (1), wherein the charging process is controlled and/or terminated after the assigned device to be charged (1) has been identified is stored and a data communication unit, wherein the computer system is arranged such that the device to be charged (1) connected to a charging station (2) is recognized by data communicated from a cloud, and its charging process is controlled and/or terminated.
